(19) United States
(12) Patent Application Publication
(10) Pub. No.: US 2004/0028935 A1
(43) Pub. Date: Feb. 12, 2004

(54) Paper towel

(76) Inventor: Harald Hauke, Spittal/Drau (AT)

Correspondence Address: YOUNG & THOMPSON, 745 SOUTH 23RD STREET 2ND FLOOR, ARLINGTON, VA, 22202

(21) Appl. No.: 10/311,235

(22) PCT Filed: Nov. 21, 2002
(86) PCT No.: PCT/AT02/00327

(30) Foreign Application Priority Data
Nov. 22, 2001 (AT) A 1838/2001

(51) Int. Cl. B32B 29/00

(52) U.S. Cl. 428/537.5; 428/608

(57) ABSTRACT

In a paper towel (1) with for example three layers (2, 3, 4) the two outer layers (3, 4) are provided with embossing (6) and the inner layer (2) is provided with printing (5). The layers (2, 3, 4) are at least partially transparent and are cemented to one another by means of a colored glue as the binder (9).

The invention relates to a paper towel with at least two layers, of which at least one layer is provided with embossing and at least one layer at least in areas is provided with printing.

Within the framework of this invention, paper towels are for example napkins, rolled paper towels for the kitchen, toilet paper, cosmetic wipes, tissues, table sets, table cloths, bibs and protective articles which contain cellulose or are produced from pulp, but can also contain layers or coatings of plastics or other materials. The initial materials in this specialty are also called “tissue”.

The object of the invention is to make available one such paper towel which with respect to its optical appearance differs from known paper towels, but which furthermore feel soft and pleasant and has satisfactory absorbency without easily delaminating or decomposing in use.

This object is achieved with a paper towel with the features of claim 1.

The invention consists of a combination of known features which, jointly applied, enables a new appearance of the print present on the paper towel, which is formed essentially in that the print image acquires a “softer” or “attenuated” appearance due to an at least partially transparent layer, since the contours of the print or the embossing do not appear so sharp due to this at least partially transparent layer, and that furthermore an additional change of the appearance of the print image is achieved by the embossing, since the print image is perceived differently by the eye of the viewer due to the elevated and recessed areas or in those areas. In particular, when viewed obliquely or when the light is obliquely incident, a type of “shadow effect” is formed. By a suitable combination of the print image and the pattern of the embossing or the orientation of the print image and of the embossed pattern to one another, an optical impression can ultimately by engendered which is similar for example to the appearance of a fabric.

The definition that at least one layer is at least partially transparent should be understood within the framework of the invention such that one layer based on its color, material property and thickness is made such that the print image shines through this layer in a more or less highly attenuated form.

The print on the paper towel can have the most varied patterns, thus for example figured patterns, such as flowers, or geometrical shapes such as lines, crosses, rectangles, triangles or sinusoidal lines, but also a combination of these patterns.

The permanent connection of the layers to one another can be done such that the layers are cemented to one another by means of a binder which is applied in the course of joining the layers. This binder can be applied to the layer(s) for example shortly before the joining of the layers in the printing or embossing rollers and can be for example a glue which is conventional in the production of these paper towels.

The layers can be cemented for example also by at least one layer of the paper towel containing a substance, for example, a polyvinyl acetate which, when the layers are joined during passage between suitable printing or embossing rollers under pressure causes the layers to adhere to one another.

Embossing within the framework of this invention is defined as the working of a layer in which this layer acquires relief-like embossing with elevated and recessed areas by passage of the layer between the embossing rollers, as is known for example from EP-A-0 370 972, the embossing pattern being preserved even after cementing the layers into the paper towel as claimed in the invention to such an extent that it can be recognized on the paper towel, optionally also after separating individual layers.

The paper towel as claimed in the invention consists of at least two layers.

But it is preferable as claimed in the invention if the paper towel has three layers, its being furthermore preferable that at least two layers are provided with embossing.

In two-ply paper towels thus the two layers can be provided with embossing. In triple-ply paper towels preferably the two outer layers are provided with embossing. In this way an optical effect very similar to the one mentioned initially can be achieved on both sides of the paper towel in a very advantageous manner.

Especially for two-ply paper towels can the print be applied on one side of the layer which is the outer side. On this outer side of the layer the print appears in its original form. When the second layer has the embossing, and the two layers are at least partially transparent, on the second side of the paper towel the optical effect as claimed in the invention is formed.

When the print conversely is located on the inside of one layer of the paper towel, i.e. one side of a layer which is facing the other layer, under the assumption that all layers are at least partially transparent, on both outer sides the print image appears in the form as claimed in the invention which is furthermore dependent on whether the print is applied to an embossed or unembossed layer.

In for example triple-ply paper towels it is possible to print the middle layer only on one side, and only the outside layer located on the printed side of the layer need be partially transparent and the print as a result is also visible only on this side of the layer. If on the other hand the middle layer and the other outer layer are partially transparent, the print can be visible on both sides of the paper towel. Furthermore, it is also possible to print both sides of the middle layer, either with the same or with a different pattern, which is visible on the respective side of the paper towel. When the middle layer is transparent, but which need not be the case, the desired optical superposition of the two print images can occur.

In the invention it is also possible to dye one or more layers in a penetrating manner, i.e. for the layer(s) to have a colored base shade regardless of the additional print image, and the color can be uniform over the entire surface area or can also be nonuniform, for example running continuously or discontinuously.

In order to join or cement the layers to one another, it is also possible for the binder to be the printing ink itself, since it naturally has a certain adhesive capacity on the carrier material of the layer(s). If the adhesive capacity of the ink is not sufficient to ensure sufficiently permanent joining of the layers, an amount of an additional binder, for example a conventional glue, which amount is more or less depending on the requirement, can be added to the printing ink.

According to one preferred embodiment the binder is however colored.

The colored binder makes it possible to superimpose another colored image on the print image. This superimposed additional image which is produced by the colored binder, if it has been applied to an embossed layer, will correspond to the embossed pattern since the binder is generally applied only to the raised areas of the embossing, conversely in the recessed areas there is no colored binder. In this embodiment the initially mentioned optical effect as claimed in the invention can be changed in addition and furthermore can be greatly intensified since, in those areas in which the layers are cemented to one another via the binder, optical superposition or intensification of the color occurs, conversely in the remaining areas, i.e. those recessed areas which are not adjacent to the neighboring layer, double optical attenuation of the print image is formed which is caused on the one hand by the absence of colored binder and on the other by the distance of the embossed layer in these areas from the print image.

Additional configuration possibilities arise by the color(s) or intensity(intensities) of the print image and those of the colored binder possibly being different.

It is also possible to achieved additional optical effects by arbitrarily or randomly differently distributed layer thicknesses of the binder. It is furthermore possible to apply the binder only in areas, for example in strip form, by which likewise additional optical effects can be achieved.

With respect to the embossing pattern as well as with respect to the print image there are many possible variations of both the pattern itself, for example geometrical or figured patterns, as well as their orientation. It is also possible to make the embossing pattern different in different surface areas of one layer and in those cases in which more than one layer is embossed, in different layers.

Preferred embodiments of the invention are detailed with reference to the drawings.

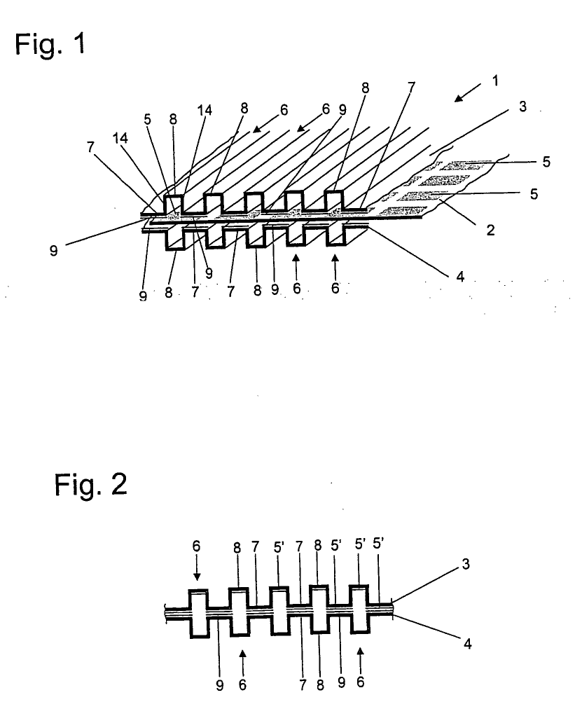

FIG. 1 shows a schematic of one section through one triple-ply embodiment of a napkin as claimed in the invention.

FIG. 2 shows a schematic of a section through a two-ply napkin as claimed in the invention.

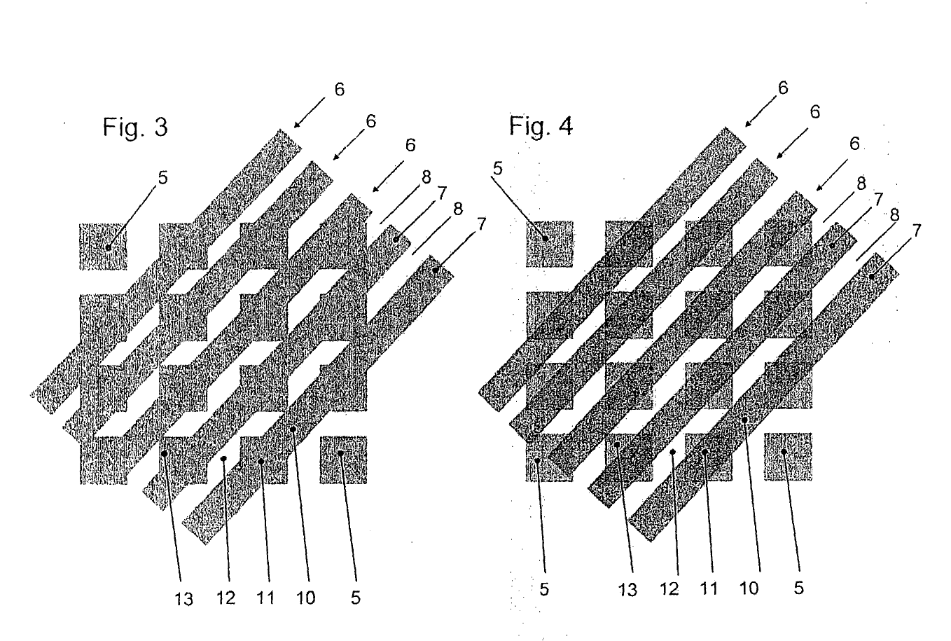

FIGS. 3 and 4 shows conventional examples for patterns which can be produced as claimed in the invention.

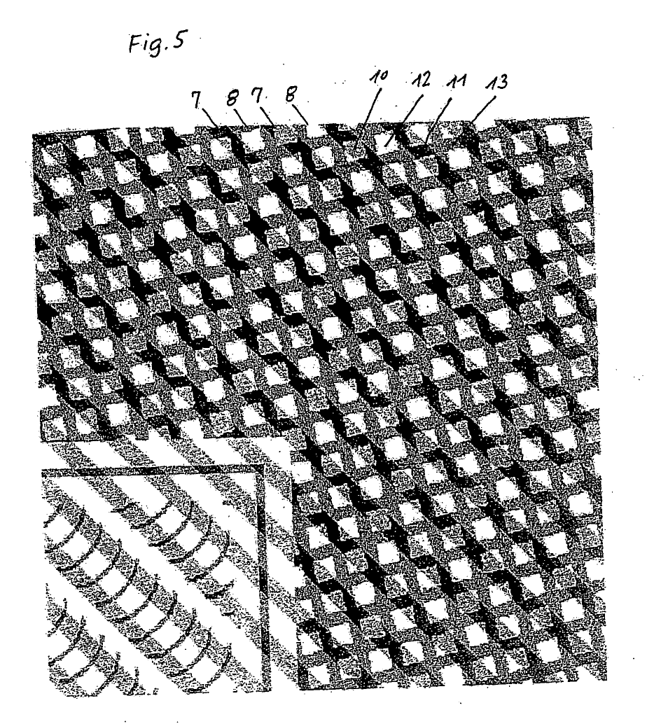

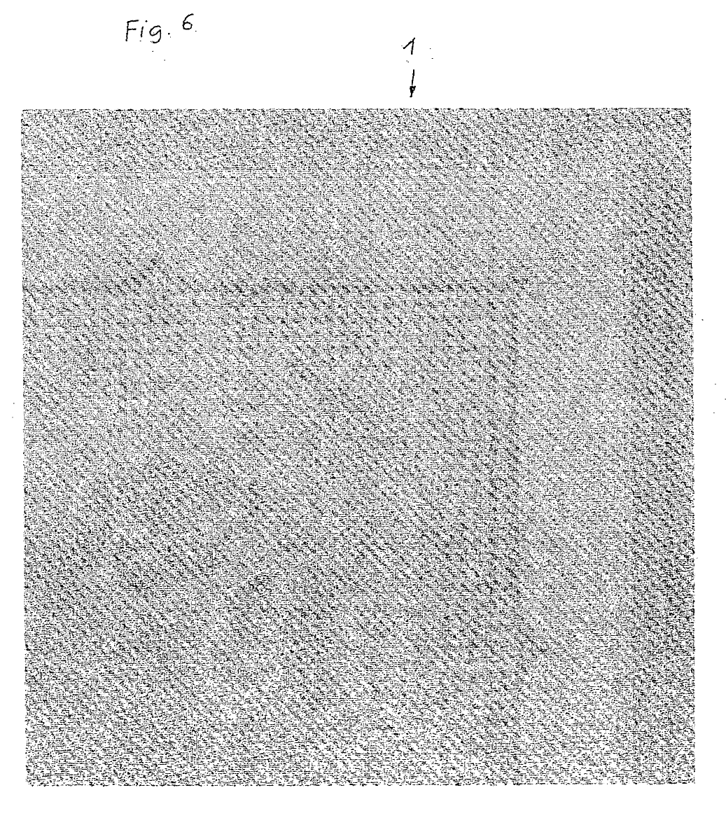

FIG. 5 shows an enlarged view of one extract of a napkin as claimed in the invention and

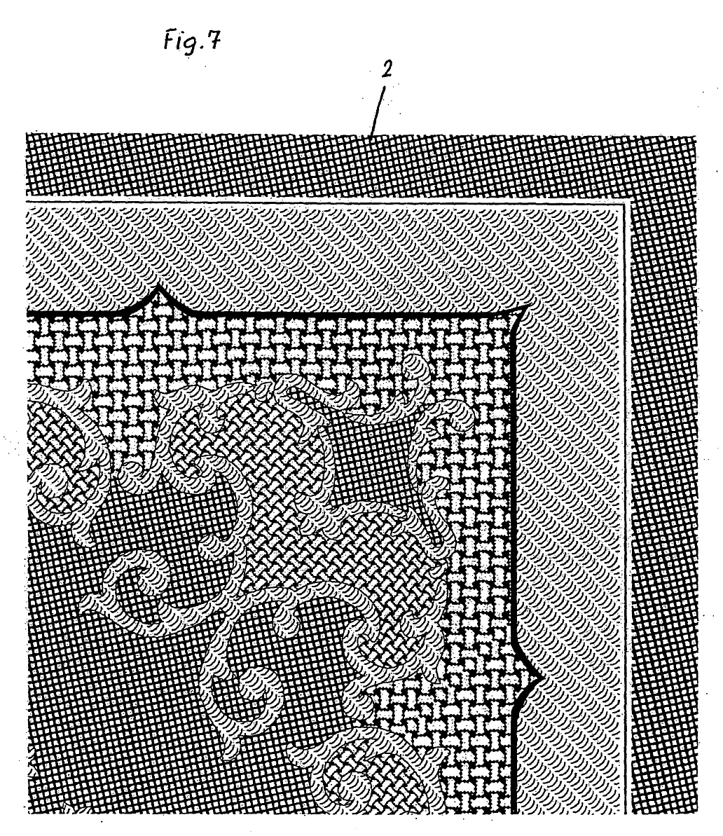

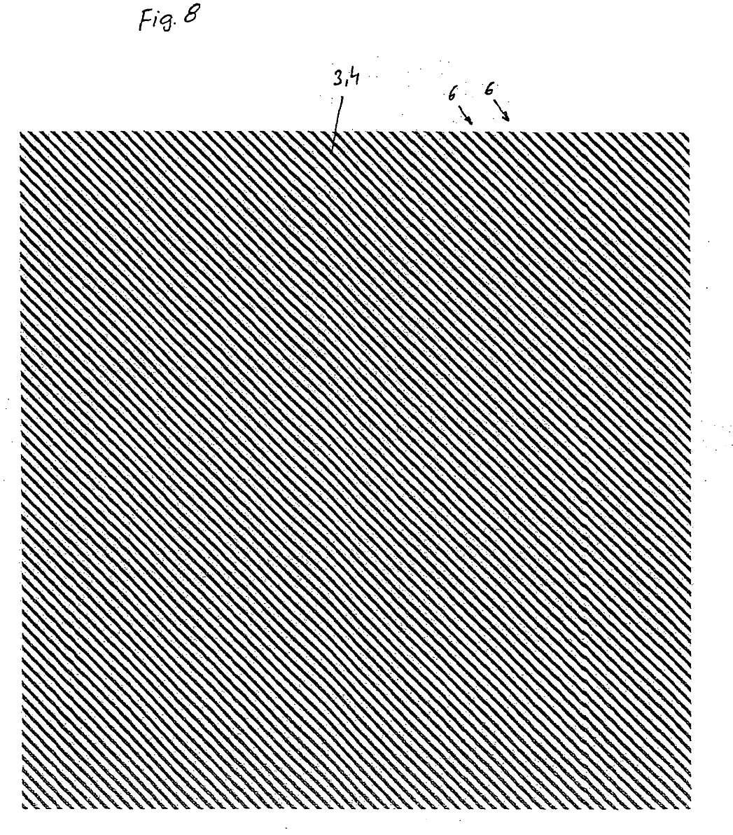

FIG. 6 a napkin as claimed in the invention which is made from a printed layer of the napkin as shown in FIG. 7 and an embossed layer provided with colored glue as shown in FIG. 8.

FIG. 1 schematically shows a first embodiment of the invention in the form of a three-ply paper towel 1, for example a napkin, which consists of a middle layer 2 and a first outer layer 3 and a second outer layer 4. The middle layer 2 on the side facing the outer layer 3 has a printed image in the form of squares or rectangles 5, as can be seen also for example in FIGS. 3 and 4. The outer layers 3 and 4 are unprinted and have embossing in the form of ribs 6. These ribs 6 have elevated areas 7 and recessed ares 8. Before joining the layers 2, 3 and 4, a colored binder, for example colored glue 9, was applied to the elevated areas 7.

The outer layer 3 is partially transparent, so that the print 5 on the middle layer 2 shines through the outer layer 3. This print is superimposed in the area of the elevated ares 7 by the colored glue 9 so that depending on the color difference between the print 5 and the binder 9 and the transparency of the binder 9 the color or the appearance of the print 5 changes.

In the recessed areas 8 there is no binder so that the printing 5 can be seen unchanged, but shadowed or attenuated by the transparency of the outer layer 3 and the distance of the recessed areas 8 from the middle layer 2.

FIGS. 3 and 4 show roughly schematically the appearance of one such paper towel, in FIG. 2 the print and the glue having roughly the same color, conversely in FIG. 4 the print 5 and glue 9 having different colors.

Using FIG. 4 it is explained that due to the superposition of the inner layer 2 and the outer layer 3 essentially four areas are formed which produce a different appearance. They are the area 10 in which the middle layer 2 is unprinted and the outer layer 3 in the elevated area 7 is colored with binder. In the area 11 the middle layer 2 is printed, the print 5 being superimposed by the colored binder 9 of an elevated area 7. In the area 12 the middle layer 2 is uncolored and also the outer layer 3 in the recessed area 6 does not have coloring by the binder 9. In the area 13 finally the middle layer 2 is printed and moreover there is a recessed area 8 of one rib 6 of the outer layer 3.

It should be added that both the middle layer 2 and also the outer layer 3, 4 have an optionally different color than the base shade, therefore can be dyed through, especially its being necessary to watch of course in the outer layer 3 that the transparency of the outer layer 3 is not undesirably reduced by this base shade.

The colors of the print 5 and the binder 9 can be different, but also can be matched to one another such that for example the areas 10 and 13 for the viewer have roughly the same color intensity, of which the areas 11 and 12 can stand out more or less dramatically.

In the embodiment shown in FIG. 3 the colors and the transparency of the outer layer 3 are matched to one another such that the areas 10, 11, and 13 have somewhat the same shade for the viewer, of which only the area 12 stands out optically.

It should be emphasized that the recessed area 8 yields an effect which cannot be easily represented in the drawings, and which differs from the embodiment in which for example the outer layer 3 as well as the inner layer 2 are largely flat and the binder 9 is applied for example in a strip shape to the outer layer 3. The distance of the recessed area 8 from the middle layer 2 and the side walls 14 of the ribs 6 yield a shadow-like optical effect which changes the overall optical impression, and which has for example similarities to a woven material.

In FIG. 1, another outer layer 4 has been furthermore applied to the bottom and corresponds to the upper layer 3 in which therefore likewise in the elevated areas 7 a colored binder 9 is applied. When the middle layer 2 is likewise partially transparent, thus on the second side which is the lower one in FIG. 1, an optical effect is formed which is comparable to that of the top, in any case is somewhat attenuated in terms of the intensity of the print 5, since the print 5 is applied to the side facing the side 3. Of course it would also be possible to likewise apply the same or different print to the side of the inner layer 2 opposite the print 5. Furthermore it is of course also possible to carry out embossing on the bottom outer layer 4 both in terms of the patterns and also of the orientation differently than the embossing on the outer layer 3, and the binder 9 also can have a different color.

FIG. 2 shows an embodiment of the invention in which the paper towel has only two outer layers 3 and 4, which are both embossed, but no middle layer 2. On the upper layer both in the elevated area 7 and also in the recessed area 8 print 5′ is applied and on the bottom layer in the area of the elevated areas 7 there is in turn a colored binder 9. By means of a suitable combination of the embossing of layers 3 and 4 which can be the same or different both with respect to its orientation and also its pattern, and the print 5′ and the color of the binder 9, in turn an attractive overall pattern of the paper towel can be formed which can differ on the front and rear side of the paper towel.

FIG. 5 shows another embodiment of a paper towel as claimed in the invention, in which a lattice-shaped print on one layer 2 which can be for example an unembossed middle layer (in for example a three-ply paper product) or an outer layer (in for example a two-ply paper product), is covered by an outer layer which is for example embossed in a strip shape, again colored glue having been used as the binder on the embossed layer. The areas 10 to 13 which are formed on the final product and which are visible to different degrees are identified in FIG. 5 according to FIGS. 3 and 4.

The section of a paper towel 1 shown in FIG. 6 in the form of a napkin was produced by placing three layers 2, 3, 4 on top of one another, as is shown in principle in FIG. 1, in FIG. 7 the printed middle layer 2 being shown, which is covered on either side by two outer layers 3, 4 which are embossed in a line and which are provided accordingly with colored glue according to FIG. 9. FIG. 6 shows that as a result a paper towel 1 is formed which causes a fabric-like impression overall, its being added again that by the representation in FIG. 6 the additional effect which is produced by the embossing 6 of the outer layers 3, 4, which embossing is rib-shaped in this example, and the resulting raised, recessed area 8 of the ribs 6, is not set off accordingly, but produces a special optical effect on the completed product.

In summary, one preferred embodiment of the paper towel as claimed in the invention can be described as follows:

In a paper towel 1 with for example three layers 2, 3, 4 the two outer layers 3, 4 are provided with embossing 6 and the inner layer 2 with print 5. The layers 2, 3, 4 are at least partially transparent and are cemented to one another by means of a colored glue as binder 9.

1. Paper towel with at least two layers (2, 3, 4), of which at least one layer (3, 4) is provided with embossing (6) and at least one layer (2) at least in areas is provided with printing (5), characterized in that at least one layer (2, 3, 4) is at least partially transparent and that the layers (2, 3, 4) are cemented to one another.

2. Paper towel as claimed in claim 1, wherein the layers (2, 3, 4) are cemented to one another by means of a binder (9) which is applied in the course of joining the layers (2, 3, 4).

3. Paper towel as claimed in claim 1 or 2, wherein it has three layers (2, 3, 4).

4. Paper towel as claimed in one of claims 1 to 3, wherein at least two layers (3, 4) are provided with embossing.

5. Paper towel as claimed in one of claims 1 to 4, wherein the print (5, 5′) is applied to at lest one side which is located within the paper towel.

6. Paper towel as claimed in one of claims 1 to 5, wherein the print (5, 5′) is applied to one side of an outer layer (2, 3) which faces the other layer (3, 2) of the paper towel.

7. Paper towel as claimed in one of claims 1 to 4, wherein the print is applied on one side of a layer which is the outer side.

8. Paper towel as claimed in one of claims 1 to 6, wherein it has three or more layers (2, 3, 4) and wherein the print (5) is applied to at least one side of the inner layer (2).

9. Paper towel as claimed in one of claims 1 to 8, wherein at least one layer (2, 3, 4) is dyed through at least in areas.

10. Paper towel as claimed in one of claims 2 to 9, wherein the binder (9) is a glue.

11. Paper towel as claimed in one of claims 2 to 9, wherein the binder (9) is a printing ink, optionally with glue or the like added.

12. Paper towel as claimed in one of claims 2 to 10, wherein the binder (9) is colored.

13. Paper towel as claimed in one of claims 2 to 10, wherein the binder (9) is colorless.

14. Paper towel as claimed in one of claims 1 to 13, wherein the embossing (6) has a uniform pattern over the entire surface of the layer (3, 4).

15. Paper towel as claimed in one of claims 1 to 13, wherein the embossing (6) has a different pattern in different surface areas of the layer.

16. Paper towel as claimed in one of claims 1 to 15, wherein the embossing (6) has a figured pattern.

17. Paper towel as claimed in one of claims 1 to 16, wherein two or optionally more layers (3, 4) have embossing (6) and wherein the embossing (6) of the different layers (3, 4) is the same.

18. Paper towel as claimed in claim 17, wherein the orientation of the embossing (6) of the layers (3, 4) is different.

19. Paper towel as claimed in one of claims 1 to 18, wherein two or optionally more layers (3, 4) have embossing (6) and wherein the embossing (6) of the layers (3, 4) is different.

20. Paper towel as claimed in one of claims 2 to 19, wherein the color of the binder (9) and the color of the print (5′) are different.

21. Paper towel as claimed in one of claims 2 to 20, wherein the thickness of the applied binder (9) is of different size in different surface areas.

22. Paper towel as claimed in one of claims 2 to 21, wherein the binder (9) is applied only in different partial areas, for example, in a strip shape.

23. Paper towel as claimed in one of claims 1 to 22, wherein at least one layer (2, 3, 4) consists entirely or partially of plastic.
